(19) United States
(12) Patent Application Publication
(10) Pub. No.: US 2018/0279633 A1
(43) Pub. Date: Oct. 4, 2018

(54) Smoker with Smoke Management System

(71) Applicant: Masterbuilt Manufacturing, LLC, Columbus, GA (US)

(72) Inventor: Lin Qiu, Columbus, GA (US)

(21) Appl. No.: 15/936,669

(22) Filed: Mar. 27, 2018

Related U.S. Application Data
(60) Provisional application No. 62/479,424, filed on Mar. 31, 2017.

(51) Int. Cl. A23B 4/056

(52) U.S. Cl. CPC A23B 4/056; A47J 37/0754

(57) ABSTRACT

A smoker for cooking a food product that has a smoke dissipater mounted inside the cabinet for dissipating smoke using a high capacity ion generator for negatively charging smoke molecules so that the negatively charged molecules agglomerate with positively charged smoke molecules resulting in heavier molecules that precipitate out of the air within the cabinet. The smoker further may include charged plates within the cabinet that attract the charged smoke molecules to further accelerate dissipation of the smoke within the cabinet. The smoker also includes an air exchanger including a low capacity ion generator, and a cabinet exhaust for continuously refreshing the smoke within the cabinet.

### CLAIM OF PRIORITY

This application claims priority from U.S. Provisional Patent Application Ser. No. 62/479,424, filed on Mar. 31, 2017, which is incorporated herein in its entirety.

### FIELD OF THE INVENTION

This invention relates to a smoker for slowly cooking food while imparting a smoked flavor to the food, and more particularly to controlling the smoke within the cabinet of the smoker.

### BACKGROUND OF THE INVENTION

When opening the door of the cabinet of a conventional smoker, the user is typically exposed to the smoke from inside the cabinet. The smoke gets into the user's clothing as well as the user's eyes. In order to avoid exposure to the smoke within the cabinet, the user typically waits with the door open for the smoke to clear before accessing the food inside of the cabinet of the smoker. Leaving the door open in order for the smoke to clear wastes heat and disrupts the smoking process.

Further, a conventional smoker cannot be used indoors because of smoke escaping into the indoor environment when the door of the smoker is opened.

### SUMMARY OF THE INVENTION

The smoker of the present invention overcomes the foregoing problems of conventional smokers. In one embodiment, the smoker of the present invention has a smoke dissipater inside the cabinet of the smoker that will dissipate the smoke inside the cabinet thereby allowing quick access to the inside of the cabinet without excess loss of heat or exposure of the user to smoke when the door of the cabinet is opened. Moreover, with the smoke dissipater, the smoker may be used in an indoor environment.

The smoke dissipater is mounted inside and near the top of the cabinet. The smoke dissipater includes a dissipater housing, a high capacity ion generator, a circulation fan, a dissipater return inlet, and a dissipater outlet. In addition, the inside of the cabinet may be fitted with charged plates to further expedite the dissipation of smoke within the cabinet of the smoker.

The high capacity ion generator of the smoke dissipater produces negatively charged molecules (anion). The smoke inside the cabin is typically comprised of positively charged molecules (cation). These positively charged smoke molecules are attracted to and bond with the negatively charged molecules. As a result, larger and heavier smoke molecules form. The agglomeration of the smoke molecules causes a “stirring” effect that will help to speed up the dissipation of the smoke. The heavier molecules and the particles precipitate out of the air and onto the grease pan at the bottom of the smoker cabinet. To speed up the dissipation process and to direct downward flow of the heavier smoke molecules, the charged plates are fitted to the inside of the cabinet to collect the charged smoke molecules.

In a second embodiment of the smoker of the present invention, and in addition to the smoke dissipater described above, the top of the cabinet is fitted with a fresh air exchanger to assure that the smoke within the cabinet does not become stale. The fresh air exchanger comprises an exchanger housing, low capacity ion generator, an exchanger fan, a fresh air inlet, a smoke return inlet, and an exchanger outlet.

The exchanger fan of the air exchanger draws fresh air into the exchanger housing through the fresh air inlets. Simultaneously, the exchanger fan draws smoke from inside the cabinet into the exchanger housing through a smoke return inlet. The mixture of fresh air and smoke pass through the low capacity ion generator negatively charging the fresh air molecules and the smoke molecules. Upon exiting the exchanger housing, the negatively charged molecules agglomerate with positively charged smoke molecules within the cabinet, and the resulting heavier molecules precipitate out of the air in the cabinet. As the fresh air is drawn into the cabinet, smoke and air are forced toward a filtered cabinet exhaust where the filter traps the smoke particles while allowing the exhaustion of air. Consequently, the smoke within the cabinet is constantly refreshed by fresh air drawn into the cabinet. The second embodiment also contemplates the use of charged plates as previously described in connection with the first embodiment.

Further objects, features and advantages will become apparent upon consideration of the following detailed description of the invention when taken in conjunction with the drawings and the appended claims.

### BRIEF DESCRIPTION OF THE DRAWINGS

FIG. 1 is a front perspective view of a smoker in accordance with the present invention.

FIG. 2 is a front elevation view of the smoker in accordance with the present invention with the door removed to reveal internal detail of the smoker.

FIG. 3 is a partial front elevation view of the smoker in accordance with the present invention showing an air exchanger and a smoke dissipater.

FIG. 4 is an enlarged section view of the air exchanger of the smoker in accordance with the present invention.

FIG. 5 is an enlarged section view of the smoke dissipater of the smoker in accordance with the present invention.

FIG. 6 is a diagram illustrating the operation of the smoke dissipater of the smoker in accordance with the present invention.

### DETAILED DESCRIPTION OF THE PREFERRED EMBODIMENT

In a first embodiment of the present invention, the smoker 10 has a smoke dissipater 56. In a second embodiment of the present invention, the smoker 10 has both the smoke dissipater 56 and an air exchanger 40.

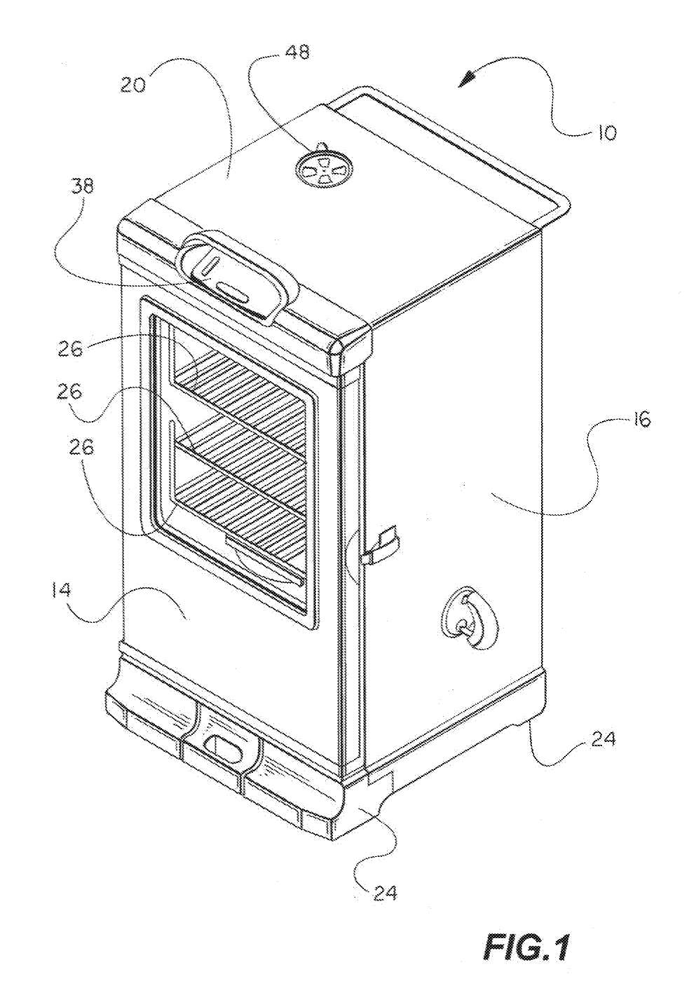

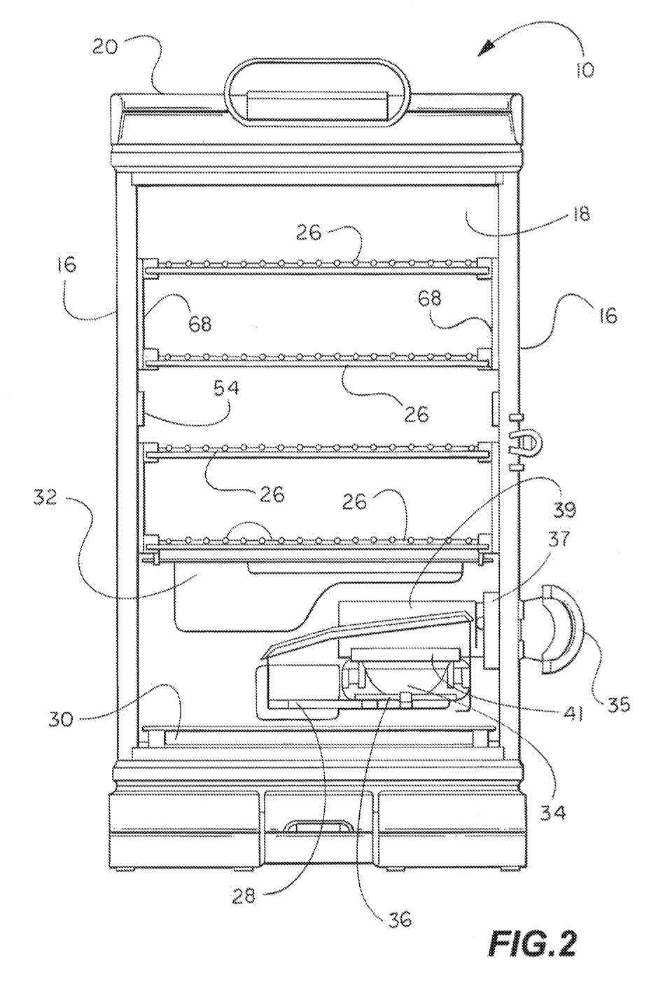

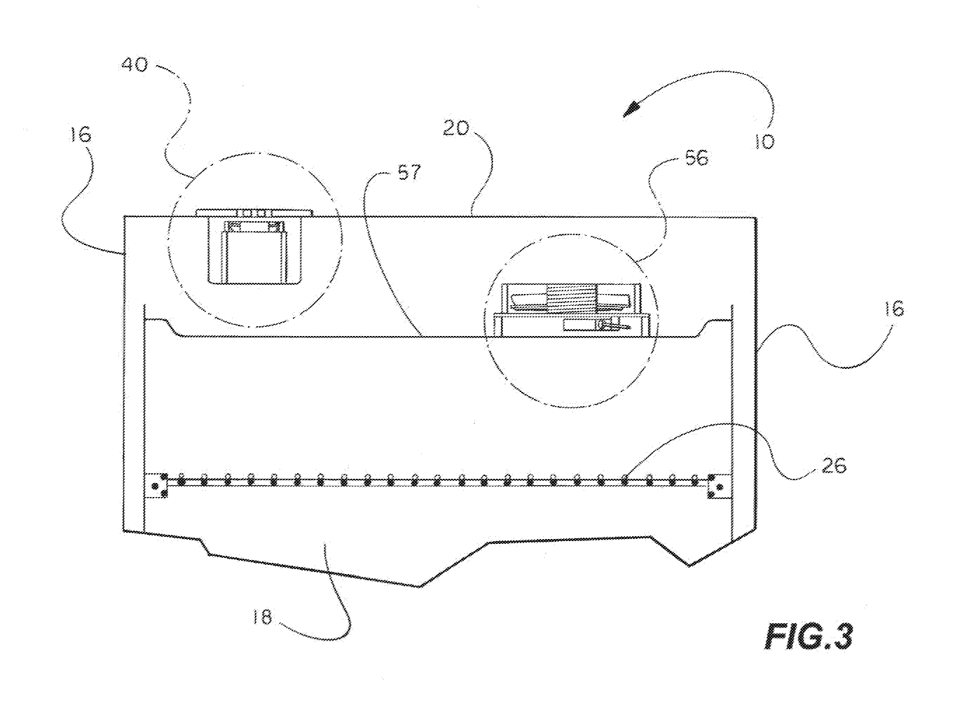

With reference to FIGS. 1-5, the first embodiment of the smoker 10 of the present invention includes a cabinet 12, having an insulated top panel 20 with a control panel 38, insulated side panels 16, an insulated back panel 18, and a hinged front door 14 with a latch 22. The cabinet 12 further includes grill racks 26 spaced vertically within the cabinet 12. As shown in FIG. 2, the smoker 10 further includes a water bowl 32 and a wood chip tray 34 near the bottom of the cabinet 12. Wood chips are fed to the wood chip tray 34 by a wood chip stoker 37. The wood chip stoker 37 comprises a cylindrical can 39 with a longitudinal opening 41. One end of the cylindrical can 39 is attached to an external handle 35 that allows the user to extract the cylindrical can 39 from the cabinet. The cylindrical can 39 is filled with wood chips and reinserted into the cabinet with the opening 41 in the top position. Once the cylindrical can 39 is inserted into the cabinet, the cylindrical can is rotated by means of the handle 35 thereby emptying the wood chips from the cylindrical can 39 into the wood chip tray 34 via the opening 41 thereby replenishing the wood chips as necessary during the smoking process. A smoke heat source 36 heats the wood chips in the wood chip tray 34 in order to generate smoke inside the cabinet 12. A primary heating element 28 is positioned near the bottom of the cabinet 12 to cook the food arrayed on the grill racks 26. A grease pan 30 is positioned below the heating element 28 in order to catch the drippings from the food on the grill racks 26.

With reference to FIGS. 2, 3, and 5, the smoke dissipater 56 is mounted on a dissipater support 57 inside the cabinet 12. The smoke dissipater 56 is located near the top of the cabinet 12. The smoke dissipater 56 includes a dissipater housing 58, a high capacity ion generator 60, a circulation fan 62, a dissipater return inlet 64, and a dissipater outlet 66. The dissipater 56 operates to dissipate smoke 70 inside the cabinet 12 before the user opens the door 14 to gain access to the food on the grill racks 26. The smoke dissipater 56 is activated by the user by means of a control panel 38 before the user opens the door 14 to gain access to the interior of the cabinet 12 and the food on the grill racks 26 during the smoking process. Once the smoke dissipater 56 is activated by the user, the smoke clears in a few minutes in order to allow smoke-free access to the inside of the cabinet 12.

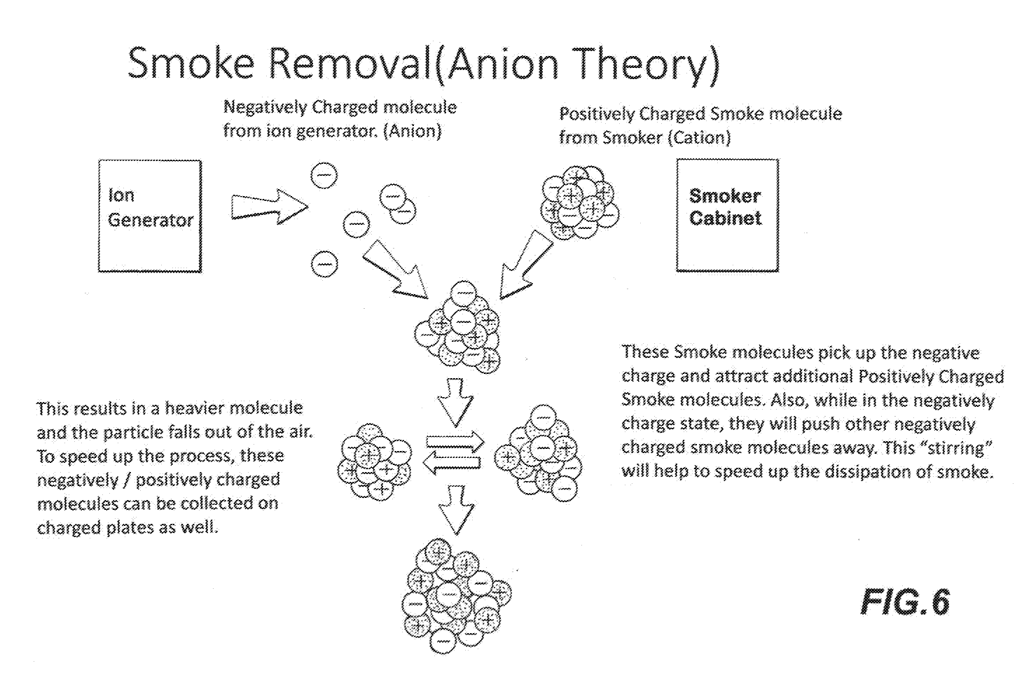

In operation and with reference to FIGS. 5 and 6, the circulation fan 62 draws smoke 70 from inside the cabinet into dissipater return inlets 64. The circulation fan 62 then directs the smoke 70 past the high capacity ion generator 60 where the smoke molecules are given a negative charge. As the negatively charged molecules exit the dissipater housing 58 through dissipater outlet 66, the negatively charged molecules encounter positively charged smoke molecules in the cabinet 12. The positively charged smoke molecules bind to the negatively charged molecules to create an agglomeration of heavier molecules that precipitate from the air in the cabinet 12 and fall to the bottom of the cabinet 12 and onto the grease pan 30. Optionally and in order to accelerate the dissipation of the smoke within the cabinet 12, charged plates 68 are positioned inside the cabinet 12. The charge plates 68 are given a positive charge so that the heavier negatively charged molecules are attracted to the charged plates 68 thereby further reducing the smoke within the cabinet 12 prior to opening the door 14. Because the smoke dissipater 56 can dissipate the smoke in the cabinet 12 prior to opening the door 14, the smoker 10 of the present invention reduces heat loss and that would otherwise occurs while the door 14 is open and waiting for the smoke to dissipate through the open door 14. Further, the smoker 10 may be used indoors without smoke filling the room.

In terms of clearing smoke using the smoke dissipater 56, smoke that results from 20 grams of typical smoking wood fills a volume of 12 in×15 in×24 and can be cleaned by the smoke dissipater 56 in about 120 seconds. The smoke clearing capability is scalable. The volume of smoke is controllable by varying the smoke input (smaller wood volume) or by increasing the capacity of the smoke dissipater 56 to produce charged particles. Use of the charged plates 68 can also increase the rate of smoke clearing.

The second embodiment of the smoker 10 further includes the air exchanger 40 and a filtered cabinet exhaust 54. The air exchanger 40 operates during the smoking process to draw fresh air into the cabinet 12 and to precipitate stale smoke from the air in the cabinet 12. In that way, the smoke in the cabinet is continuously refreshed during the smoking process, and filtered air is exhausted from the cabinet 12 through the filtered cabinet exhaust 54.

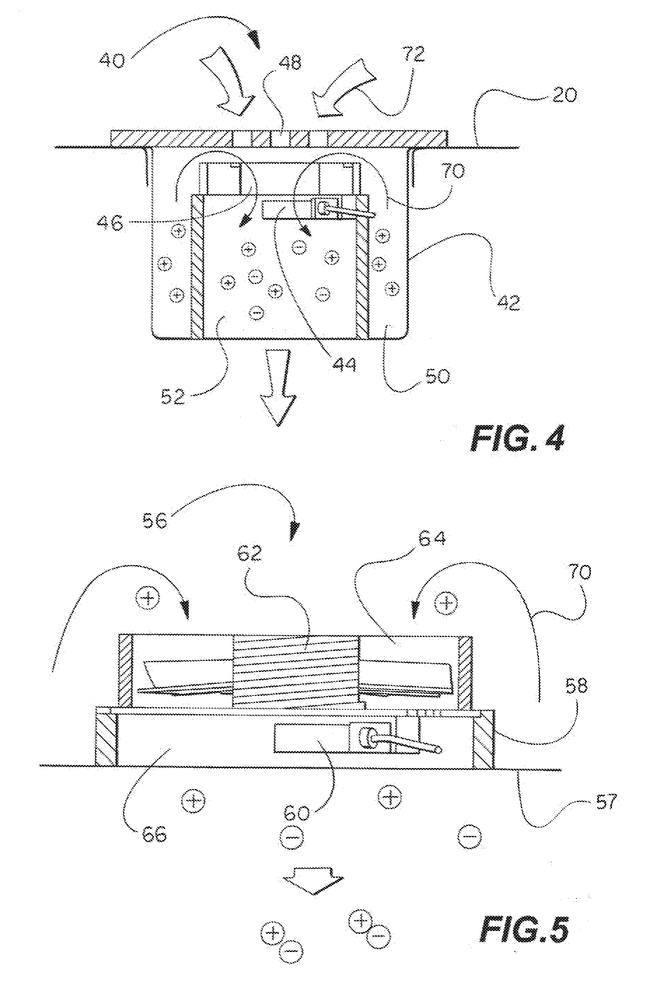

With reference to FIGS. 1, 2, 3, and 4, the air exchanger 40 is mounted in the top panel 20 of the cabinet 12. As shown in greater detail in FIG. 4, the air exchanger 40 includes an exchanger housing 42, a fresh air inlet 48 (FIG. 1), a smoke return inlet 50, an exchanger fan 46, a low capacity ion generator 44, and an exchanger outlet 52.

In operation, the exchanger fan 46 draws fresh air 72 into the exchanger housing 42 through fresh air inlets 48. Likewise, the exchanger fan 46 draws smoke 70 from the inside of the cabinet 12 into the exchanger housing 42 where the fresh air 72 and the smoke 70 mix before passing by the low capacity ion generator 44. As the mixture of smoke 70 and fresh air 72 pass the low capacity ion generator 44, the molecules in the mixture are given a negative charge. As the negatively charged molecules exit the exchanger housing 42 through exchanger outlet 52, the negatively charged molecules encounter positively charged smoke molecules in the cabinet 12. The positively charged smoke molecules bind to the negatively charged molecules to create an agglomeration of heavier molecules that precipitate from the air in the cabinet 12 and fall to the bottom of the cabinet 12 and onto the grease pan 30. In addition, the cabinet 12 has a filtered cabinet exhaust 54 (FIG. 2) that allows air that has a low smoke content to exit the cabinet 12 as fresh air 72 is drawn into the cabinet 12 by the exchanger fan 46.

While this invention has been described with reference to preferred embodiments thereof, it is to be understood that variations and modifications can be affected within the spirit and scope of the invention as described herein and as described in the appended claims.

I claim:

1. A smoker for cooking a food product comprising:
a. a cabinet with a top, a bottom, sides, a back, an access door, and at least one rack vertically located within the cabinet for holding the food product to be cooked;
b. a source of smoke for imparting a smoked flavor to the food product; and
c. a smoke dissipater mounted inside the cabinet for dissipating smoke within the cabinet, the smoke dissipater including:
i. a high-capacity ion generator for charging smoke molecules; and
ii. a circulation fan for drawing smoke molecules into the ion generator, wherein the charged smoke molecules upon exiting the smoke dissipater agglomerate with other smoke molecules and precipitate out of the air within the cabinet.

2. The smoker of claim 1, wherein the smoker further includes charged plates within the cabinet that attract the charged smoke molecules to further accelerate dissipation of the smoke within the cabinet.

3. The smoker of claim 1, wherein the smoker further comprises an air exchanger and a filtered cabinet exhaust, wherein the air exchanger includes:
a. a low capacity ion generator for charging molecules; and
b. an air exchanger fan for drawing fresh air and recirculated smoke into the ion generator, wherein air is exhausted through the filtered cabinet exhaust as fresh air is drawn into the cabinet by the air exchanger fan.

4. A smoker for cooking a food product comprising:
a. a cabinet with a top, a bottom, sides, a back, an access door, and at least one rack vertically located within the cabinet for holding the food product to be cooked;
b. a source of smoke for imparting a smoked flavor to the food product;
c. an air exchanger for refreshing smoke in the cabinet including:
i. a low capacity ion generator for charging molecules; and
ii. an air exchanger fan for drawing fresh air and recirculated smoke into the ion generator, wherein air is exhausted through the filtered cabinet exhaust as fresh air is drawn into the cabinet by the air exchanger fan.
